(19) United States
(12) Patent Application Publication
(10) Pub. No.: US 2020/0164456 A1
(43) Pub. Date: May 28, 2020

(54) METHOD AND SYSTEM FOR PREPARING MACHINING AND/OR CUTTING OF A BAR MATERIAL

(71) Applicant: TOMOLOGIC AB, Stockholm (SE)

(72) Inventor: Magnus NORBERG OHLSSON, Stockholm (SE)

(73) Assignee: TomoLogic AB, Stockholm (SE)

(21) Appl. No.: 16/611,671

(22) PCT Filed: Apr. 25, 2018
(86) PCT No.: PCT/SE2018/050421

§ 371 Date: Nov. 7, 2019

(30) Foreign Application Priority Data
May 8, 2017 (SE) 1750564-5

(51) Int. Cl. B23K 10/00; B23K 7/10; B23K 103/04; B24C 1/04; B23K 101/04; B26D 5/00; B26F 3/00; G05B 19/4097; B23K 26/38

(52) U.S. Cl. CPC B23K 10/00; B23K 7/10; B23K 2103/04; B24C 1/045; B23K 26/38; B26D 5/00; B26F 3/004; G05B 19/4097; B23K 2101/04

(57) ABSTRACT

A method of preparing machining and/or cutting of a bar material, comprising the steps of obtaining a set of geometries to be machined and/or cut from a bar material; calculating at least one length of a bar material based on the geometries; presenting the at least one calculated length of a bar material; and deciding on a length of a bar material at least based on the at least one presented length of a bar material. Further described is a system for preparing machining and/or cutting of a bar material, wherein the system comprises a receiver for obtaining a set of geometries to be machined and/or cut from a bar material; a calculator for calculating a length of a bar material based on the geometries; a presentation unit for presenting the calculated length of a bar material; and a decision unit for deciding on a length of a bar material based on the presented length of a bar material.

### TECHNICAL FIELD

Aspects of the present invention relate to a method and a system for preparing machining and/or cutting of a bar material, to a method and system for machining and/or cutting a bar material, to at least one computer program product and to a non-transient computer-readable storage medium containing data representing coded instructions.

### BACKGROUND

There are various machining and cutting technologies available to cut parts out of a bar material. The parts may be cut out by e.g. beam cutting. Beam cutting is defined as having some kind of beam as the cutting means, such as laser cutting, plasma cutting, ion beam cutting, flame or torch cutting, water cutting, or air cutting. Other examples of machining and cutting methods are sawing and turning, e.g. With conventional machining or cutting of a bar material, there is a problem with waste. A normal production has 5-30 percent waste. Thus, it is in general desirable to minimize the amount of waste material. Typically, bar material is ordered in standard lengths, e.g. in lengths of 6 meters, and a quantity of one ton, for example. Conventionally, each geometry to be cut is defined with a cutting path which converts the geometry into a single part to be machined or cut. Single parts are then positioned with a safety distance to each other on the bar material with so called nesting optimization methods. One source of waste is the scrap material formed by the safety distances provided between parts being cut out from the bar material.

### SUMMARY

The present invention relates to cutting and/or machining geometries from a bar material. The bar material may for example be in the form of a tube, a flat bar, a round bar, a square bar, carrier, profile, angle section etc. A bar material is different from a sheet material.

The inventor of the present invention has identified shortcomings in prior-art machining of geometries from a bar material. For example, the inventor has identified another source of waste, namely the discrepancies between the length of geometries to be cut and the length of the bar material in stock or ordered as a standard length.

An object of embodiments of the present invention is to improve the machining and/or cutting of geometries from a bar material.

Another object of embodiments of the present invention is to reduce the amount of scrap/waste produced when machining or cutting a set of geometries from a bar material.

At least one of the above-mentioned objects is attained by providing a method for preparing machining and/or cutting of a bar material, the method comprising the steps of:
obtaining a set of geometries to be machined and/or cut from a bar material;
calculating at least one length of a bar material based on the geometries;
presenting the at least one calculated length of a bar material; and
deciding on a length of a bar material at least based on the at least one presented length of a bar material.

By means of the inventive method, the efficiency of manufacturing the set of geometries is improved. An aspect of the present invention is that the length of a bar material is decided after the calculation of at least one length of a bar material. According to an advantageous embodiment of the method according to the present invention, the step of calculating at least one length of a bar material includes the positioning of the set of geometries on a bar material. The present invention has the advantage that the length of a bar material used in subsequent machining/cutting can be optimized. By means of the method according to the present invention, the amount of scrap produced can be reduced. By means of the inventive method, the manufacturing costs can be reduced.

According to an advantageous embodiment of the method according to the present invention, the step of presenting the at least one calculated length of a bar material comprises the step of presenting the at least one calculated length of a bar material to a bar material provider or producer which provides or produces bar material lengths. Alternatively, the bar material provider or producer may present a group of lengths of a bar material to be matched to the at least one calculated length of a bar material, and based on said matching one length of a bar material may be selected from the group. The bar material provider or producer may be a bar material provider providing bar material lengths. The bar material provider or producer may be a bar material producer producing bar material lengths.

According to a further advantageous embodiment of the method according to the present invention, the at least one decided length of a bar material is produced by the bar material producer after deciding on the length of a bar material and/or after checking the accessibility of the at least one length of a bar material at the bar material producer.

According to another advantageous embodiment of the method according to the present invention, a central computer creates instructions to be communicated to the bar material provider or producer and communicates with the bar material provider or producer.

According to a further advantageous embodiment of the method according to the present invention, the method is characterized by the step of receiving feedback from the bar material provider or producer, and wherein the step of deciding on a length of a bar material is at least based on the feedback from the bar material provider or producer. However, the step of deciding can be performed without feedback from the material provider or producer, and can e.g. be based on other information input, e.g. feedback or data from a central computer.

According to another advantageous embodiment of the method according to the present invention, the received feedback from the bar material provider or producer includes the accessibility of the at least one length of a bar material. However, the accessibility of the at least one length of a bar material may be checked or controlled without receiving feedback from the bar material provider or producer, e.g. from data or information from another source, e.g. a central computer.

According to still another advantageous embodiment of the method according to the present invention, the bar material provider or producer includes a computer-readable storage medium or a database including lengths of bar materials. Alternatively, the computer-readable storage medium or a database may be located elsewhere, e.g. be associated with a central computer.

According to yet another advantageous embodiment of the method according to the present invention, the method is characterized by the step of communicating the presented and/or decided length of a bar material to a machining and/or cutting facility.

According to an advantageous embodiment of the method according to the present invention, the method is characterized by the step of receiving feedback from the machining and/or cutting facility, and in that the step of deciding on a length of a bar material is at least based on the feedback from the machining and/or cutting facility. Alternatively, the step of deciding on a length of a bar material may be performed without feedback from the machining and/or cutting facility. The step of deciding on a length of a bar material may at least be based on other data communicated from other sources, e.g. a central computer.

According to a further advantageous embodiment of the method according to the present invention, the method is characterized by the step of communicating with a delivery service configured to deliver bar material from the bar material provider or producer to the machining and/or cutting facility.

According to another advantageous embodiment of the method according to the present invention, the bar material provider or producer presents accessible bar material or a plurality of accessible bar material candidates, e.g. via a central computer, and the step of calculating at least one length of a bar material based on the geometries includes finding the best fit with accessible length or lengths of bar material.

According to yet another advantageous embodiment of the method according to the present invention, the step of calculating at least one length of a bar material based on the geometries comprises calculating the extension of the positioned geometries and/or calculating the amount of scrap material obtained from the bar material, wherein the extension at least represents a kerf width for machining or cutting the bar material, and the method is characterized by including the extension and/or the amount of scrap material in the presentation of the at least one calculated length.

According to still another advantageous embodiment of the method according to the present invention, the step of presenting the at least one calculated length of a bar material comprises presenting a candidate set of lengths of bar material, and the step of deciding on a length of a bar material comprises selecting a best fit of lengths from the candidate set of lengths of bar material.

According to an advantageous embodiment of the method according to the present invention, the step of calculating at least one length of a bar material comprises repeatedly altering the positioning of the set of geometries, and the step of deciding on a length of a bar material comprises deciding on a best fit of lengths to the altered positioning of the set of geometries in order to obtain a candidate set of lengths of bar material.

According to a further advantageous embodiment of the method according to the present invention, the at least one calculated, presented and/or decided length of a bar material is dynamically monitored and/or controlled.

According to another advantageous embodiment of the method according to the present invention, the method is characterized by the step of creating machining and/or cutting instructions for machining and/or cutting the set of geometries from a length of a bar material. The decided length of a bar material may be cut or machined according to the set of geometries.

At least one of the above-mentioned objects of the present invention is also achieved by providing a machining and/or cutting method, comprising a method as claimed in any of the claims 1 to 17, and characterized by machining and/or cutting the set of geometries from the decided length of a bar material.

At least one of the above-mentioned objects of the present invention is also attained by providing a system for preparing machining and/or cutting of a bar material, wherein the system comprises a receiver for obtaining a set of geometries to be machined and/or cut from a bar material, a calculator for calculating at least one length of a bar material based on the geometries, a presentation unit for presenting the at least one calculated length of a bar material, and a decision unit for deciding on a length of a bar material at least based on the at least one presented length of a bar material. The advantages of the system according to the present invention corresponds to the advantages of the method disclosed above.

According to an advantageous embodiment of the system according to the present invention, the presentation unit is arranged to present the at least one calculated length of a bar material to a bar material provider or producer which provides or produces bar material lengths.

According to another advantageous embodiment of the system according to the present invention, the system comprises a central computer arranged to create instructions to be communicated to the bar material provider or producer and arranged to communicate with the bar material provider or producer.

According to a further advantageous embodiment of the system according to the present invention, the receiver is arranged to receive feedback, e.g. accessibility of the at least one length of a bar material, from the bar material provider or producer, and the decision unit is arranged to decide on a length of a bar material at least based on the feedback from the bar material provider or producer.

According to another advantageous embodiment of the system according to the present invention, the bar material provider or producer includes a computer-readable storage medium or a database including lengths of bar materials.

According to yet another advantageous embodiment of the system according to the present invention, the system comprises a communication device for communicating the presented and/or decided length of a bar material to a machining and/or cutting facility.

According to still another advantageous embodiment of the system according to the present invention, the communication device is arranged to receive feedback from the machining and/or cutting facility, and the decision unit is arranged to decide on a length of a bar material at least based on the feedback from the machining and/or cutting facility.

According to an advantageous embodiment of the system according to the present invention, the communication device is arranged to communicate with a delivery service configured to deliver bar material from the bar material provider or producer to the machining and/or cutting facility.

According to a further advantageous embodiment of the system according to the present invention, the presentation unit is arranged to the present a candidate set of lengths of bar material, and in that the decision unit is arranged to select a best fit of lengths from the candidate set of lengths of bar material.

According to another advantageous embodiment of the system according to the present invention, the system comprises a monitor for dynamically monitoring and/or controlling the at least one calculated, presented and/or decided length of a bar material.

According to yet another advantageous embodiment of the system according to the present invention, the system is arranged to create machining and/or cutting instructions for machining and/or cutting the set of geometries from a length of a bar material. Machining and/or cutting equipment may be arranged to machine and/or cut the bar material based on the created machining and/or cutting instructions.

Further, at least one of the above-mentioned objects of the present invention is achieved by providing a machining and/or cutting system comprising a system as claimed in any of the claims 20 to 30 or as disclosed above or below, and characterized in that the machining and/or cutting system comprises machining and/or cutting equipment for machining and/or cutting the set of geometries from the decided length of a bar material.

At least one of the above-mentioned objects of the present invention is also attained by providing at least one computer program product directly loadable into the internal memory of at least one digital computer, comprising software code portions for performing the steps of the method according to any of the claims 1 to 19, or according to any embodiment of the method disclosed herein above or below. when said at least one product is/are run on said at least one computer.

In addition, at least one of the above-mentioned objects of the present invention is also attained by a non-transient computer-readable storage medium containing data representing coded instructions configured for execution by a processor of a computer, the instructions comprising the steps of a method as claimed in any of the claims 1 to 19, or steps of any embodiment of the method disclosed herein above or below.

Further advantageous embodiments and aspects of the methods, systems and computer programs, respectively, according to the present invention and further advantages with the present invention emerge from the dependent claims and the detailed description of embodiments.

### BRIEF DESCRIPTION OF THE DRAWINGS

The present invention will now be described, for exemplary purposes, in more detail by way of embodiments and with reference to the enclosed drawings, in which:

FIG. 1 is a flow chart illustrating aspects of the method according to the present invention;

FIG. 2 is a flow chart illustrating additional aspects of the method according to the present invention;

FIG. 3 a schematic diagram illustrating steps of the method according to an embodiment of the invention;

FIG. 4A is a block diagram illustrating aspects of the system according to the present invention;

FIG. 4B is a block diagram illustrating further aspects of the system according to the present invention; and

FIG. 5 is a schematic diagram of some computer program products according to aspects of the present invention.

### DETAILED DESCRIPTION OF EMBODIMENTS

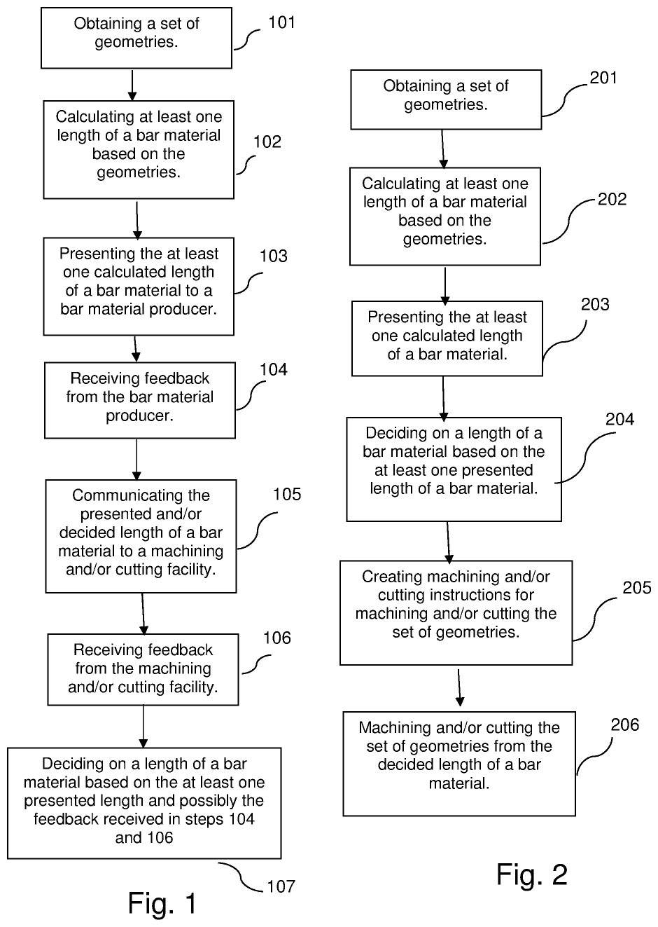

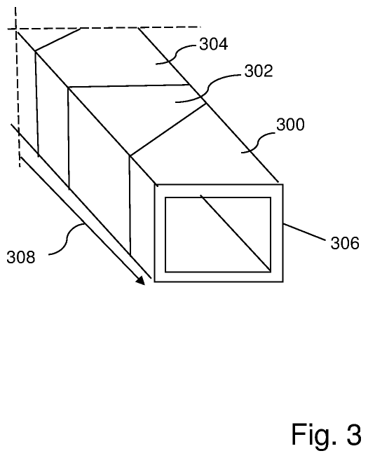

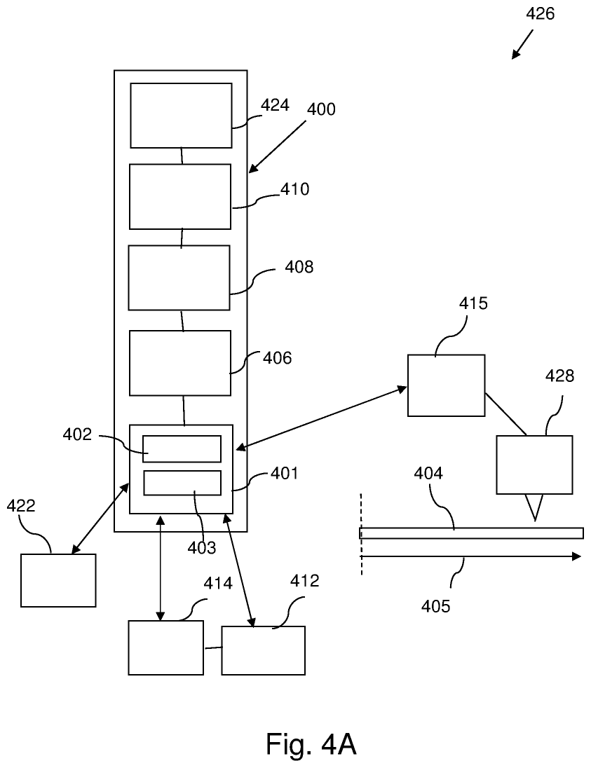

FIG. 1 schematically shows aspects of the method for preparing machining and/or cutting of a bar material 306 according to the present invention. With reference to FIG. 1, the method includes the step of obtaining 101 a set of geometries 300, 302, 304 (see FIG. 2) to be machined and/or cut from a bar material 306. The step of obtaining 101 a set of geometries 300, 302, 304 may comprise retrieving data of said geometries 300, 302, 304 from a consolidated memory in association with a computer system, such as an enterprise resource planner, ERP, or manufacturing execution system, MES, or other management system. Each geometry 300, 302, 304 may be irregular. The set of geometries 300, 302, 304 may be irregular. The set of geometries may be represented as free-form shapes. Each geometry of the set of geometries may define a free-form shape, i.e. be represented by its own contour upon the positioning of the set of geometries. The positioning of the set of geometries is further disclosed below. The geometries 300, 302, 304 and the bar material 306 are further disclosed in connection with FIG. 3 herein below.

The method further comprises the step of calculating 102 at least one length 308, 405 of a bar material 306 based on the geometries 300, 302, 304. The step of calculating 102 at least one length of a bar material may include the step of positioning the set of geometries 300, 302, 304 onto the bar material 306, e.g. positioning irregular bar material geometries 300, 302, 304 and/or geometries represented by their contour. The step of calculating 102 at least one length 308, 405 of a bar material 306, 404 may comprise the step of combining a plurality of lengths to a combined length, comparing the combined length with a maximal accepted length, and the step of dividing said combined length to a plurality of lengths, which are all of lengths equal to or less than said maximal accepted length. Alternatively, the step of calculating 102 at least one length 308, 405 of a bar material 306, 404 based on the geometries 300, 302, 304 comprises calculating the extension of the positioned geometries 300, 302, 304 and calculating the amount of scrap material obtained from the bar material 306, 404 and including the extension and/or the amount of scrap material in the presentation (see below) of the at least one calculated length 308, 405. A kerf is a slit or notch made by a sawing or cutting tool. The “extension” mentioned above may at least represent a kerf width for machining or cutting the bar material 306, 404. The “extension” may also include safety distances between the geometries to be cut. The “extension” may also include extra material needed to fasten the material during cutting, e.g. in a chuck. The “extension” may also include extra material needed for clean cutting in the beginning and in the end of the cutting/machining of the bar material.

The method further comprises the step of presenting 103 the at least one calculated length 308, 405 of a bar material 306, 404. The step of presenting 203 the at least one calculated length 308, 405 of a bar material 306, 404 may comprise the step of presenting the at least one calculated length 308, 405 of a bar material 306, 404 to a bar material provider or producer, which provides or produces bar material. The bar material provider or producer may be a bar material provider providing bar material lengths. The bar material provider or producer may be a bar material producer producing bar material lengths. The method may include communicating commands, or instructions, to the bar material producer 412 whereupon the bar material producer 412 produces the at least one length 308 of a bar material. Thus, in this embodiment the at least one length 308 of a bar material is produced by the bar material producer 412 after commands or instructions have been received by the bar material producer 412 (on-demand). Further, according to embodiments the at least one length 308 of a bar material may be produced by the bar material producer 412 after the step of calculating at least one length 308, 405 of a bar material 306, 404. The method may include receiving 104 feedback from the bar material producer. The method may include the step of communicating 105 the presented and/or decided length 308, 405 of a bar material to a machining and/or cutting facility for cutting/machining the set of geometries from a bar material. The method may also include the step of receiving feedback 106 from the machining and/or cutting facility.

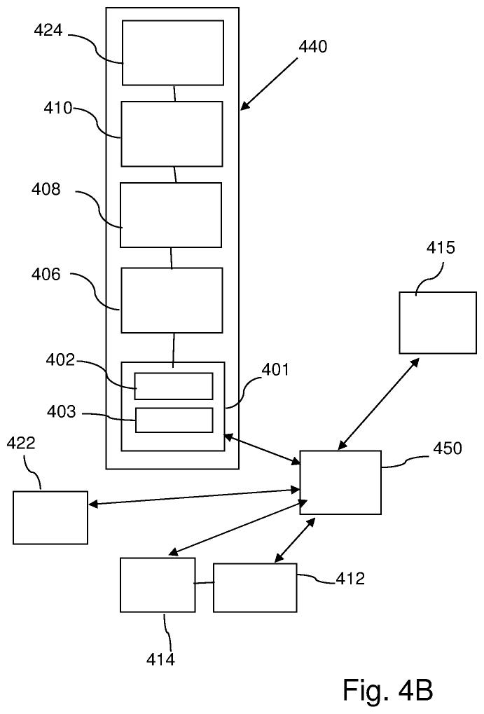

The last step of the embodiment in FIG. 1 is the step of deciding 107 on a length 308, 405 of a bar material based on the at least one presented length 308, 405 and possibly based on the feedback from the bar material provider or producer and/or the machining and/or cutting facility. Alternatively, the step of deciding may be based on other data/information input, or communication of data, instead of feedback from the bar material producer. The at least one length 308 of a bar material is transported and delivered to the machining and/or cutting facility 415 (see FIG. 4A).

By means of the inventive method, the transportation of the bar material, e.g. between the bar material provider or producer and the machining and/or cutting facility, or within the machining and/or cutting facility, is made more efficient, since only the material to become geometrises are transported, not the scrap. Thus, the costs for transportation are reduced. The space used for keeping material in stock can be reduced, since no scrap material is kept in stock, or less scrap material is kept in stock. Thus, the costs for keeping the bar material in stock are reduced. In general, by means of the inventive method, the manufacturing costs can be reduced.

The step of presenting 103 the at least one calculated length 308, 405 of a bar material 306, 404 may comprise presenting a candidate set of lengths of bar material 306, 404, and the step of deciding on a length 308, 405 of a bar material 306, 404 may comprise selecting a best fit of lengths from the candidate set of lengths of bar material 306, 404. The received feedback from the bar material provider or producer may also include the accessibility of the at least one length 308, 405 of a bar material 306, 404. Checking or controlling the accessibility of the at least one length 308, 405 of a bar material 306, 404 may be performed without feedback from the bar material provider or producer, e.g. by receiving data from a central computer in real-time. Checking or controlling the accessibility may be done via a multiple data source, e.g. a manufacturing execution system, MES, enterprise resource planning, ERP, computer aided design, CAD, computer aided manufacturing, CAM, or customer relationship management, CRM. The management system may be in connection with the bar material provider or producer. Checking or controlling the accessibility may be done via a central computer which is connected or connectable with the bar material provider or producer. Checking or controlling the accessibility of the at least one length 308, 405 of a bar material 306, 404 may be performed in real-time, e.g. by a central computer.

First after the check or control of the accessibility of the at least one length 308, 405 of a bar material 306, 404, e.g. by a central computer, e.g. in real-time, the at least one length of a bar material may be produced by the bar material producer 412 (on-demand). Thus, the bar material producer 412 does not need to store specific bar material lengths but produces lengths of a bar material on demand. According to aspects of the embodiments of the present invention, none or smaller storage is required at the bar material producer 412. The amount of transports is reduced, and the waste is reduced.

The bar material provider or producer is in most cases an external provider or producer, e.g. both external to a machining and/or cutting facility and to the entity performing the aspects of the method.

The step of calculating at least one length 308, 405 of a bar material 306, 404 may comprise repeatedly altering the positioning of the set of geometries, and the step of deciding on a length 308, 405 of a bar material 306, 404 may comprise deciding on the best fit of lengths to the altered positioning of the set of geometries, in order to obtain a candidate set of lengths of a bar material 306, 404.

The bar material provider or producer 412 may present accessible bar material 306, 404 or a plurality of accessible bar material candidates, e.g. via a central computer, and the step of calculating 102 at least one length 308, 405 of a bar material 306, 404 based on the geometries 300, 302, 304 may include finding the best fit with accessible length 308, 405 or lengths of bar material 306, 404.

The method may include the step of communicating with a delivery service configured to deliver bar material 306, 404 from the bar material provider or producer to the machining and/or cutting facility. The at least one calculated, presented and/or decided length 308, 405 of a bar material 306, 404 may be dynamically monitored and/or controlled. The method may be implemented as a computer aided design, CAD, tool, and/or a computer aided manufacturing, CAM, tool.

With reference to FIG. 2, aspects of the machining and/or cutting method according to the present invention are illustrated. Steps 201 to 204 corresponds to steps 101-103 and 107 of FIG. 1 and are thus not discussed in further detail. The method comprises the step of creating 205 machining and/or cutting instructions for machining and/or cutting the set of geometries 300, 302, 304 from a length 308, 405 of a bar material 306, 404. In step 206, the set of geometries is machined and/or cut from the decided length 308, 405 of a bar material 306, 404. The machining and/or cutting may include any of turning, sawing, beam cutting, e.g. laser cutting, plasma cutting, ion beam cutting, flame or torch cutting, water cutting, or air cutting.

The step of calculating at least one length 308, 405 of a bar material 306, 404 based on the geometries, the step of presenting the at least one calculated length 308, 405 of a bar material 306, 404, and the step of deciding 107, 204 on a length of a bar material at least based on the at least one presented length of a bar material may be performed by means of at least one computer including a processor.

With reference to FIG. 3, a set of geometries 300, 302, 304 positioned on a bar material 306 is schematically illustrated. It is to be understood that more or fewer geometries may be included in the set of geometries. In FIG. 3, the bar material is in the form of square tube, but may be have other shapes, e.g. the bar material may be in form of a bar, a pipe, a special profile, a carrier, an angle profile, a round tube, a wire, a flat bar, a round bar, square bar, a U/C profile. Geometries 300, 302, 304 obtained in steps 101 and 202 may be in 1D, 2D or 3D. The bar material 306 may be of any type of material, e.g. metal. The metal may e.g. be steel, stainless steel, Aluminium, Copper, Brass, Titanium, or mixtures thereof etc. The set of geometries 300, 302, 304 may comprise one common cut or a plurality of common cuts between the geometries 300, 302, 304 of the set of geometries 300, 302, 304. The set of geometries 300, 302, 304 may comprise one safety distance or a plurality of safety distances between the geometries 300, 302, 304 of the set of geometries 300, 302, 304. The set of geometries 300, 302, 304 may comprise extra material needed to fasten the bar material, e.g. in a cuck etc. The set of geometrises may also include extra material needed for clean cutting in the beginning and in the end of the cutting/machining of the bar material.

With reference to FIG. 4A (and FIG. 3), aspects of the system 400 according to the present invention are schematically illustrated. The system 400 for preparing machining and/or cutting of a bar material 306, 404 comprises a communication device 401 which may be arranged to communicate by means of a receiver 402 and a transmitter 403. The receiver and transmitter 402, 403 may be in the form of a transmitter-receiver, or a transceiver. However, the receiver 402 and transmitter 403 may also be separate units. The receiver 402 is arranged to obtain a set of geometries 300, 302, 304 to be machined and/or cut from a bar material 306, 404. The system further comprises a calculator 406 for calculating at least one length 405 of a bar material 306, 404 based on the geometries 300, 302, 304. The system 400 also includes a presentation unit 408 for presenting the at least one calculated length 308, 405 of a bar material 404. Further, the system 400 comprises a decision unit 410 for deciding on a length 308, 405 of a bar material 306, 404 at least based on the at least one presented length 308, 405 of a bar material 306, 404.

The presentation unit 408 may be arranged to present the at least one calculated length 308, 405 of a bar material 306, 404 to a bar material provider or producer 412, which produces bar material. The bar material provider or producer 412 may include a computer-readable storage medium or a database 414 including lengths of bar materials. The communication device 401 may be arranged to communicate with the bar material provider or producer 412 and the database 414. The receiver 402 may be arranged to receive feedback, e.g. accessibility of the at least one length 308, 405 of a bar material 306, 404, from the bar material provider or producer 412. The decision unit 410 may be arranged to decide on a length 308, 405 of a bar material 306, 404 at least based on the feedback from the bar material provider or producer 412. The communication device 401 is arranged to communicate the presented and/or decided length 308, 405 of a bar material 306, 404 to a machining and/or cutting facility 415 for cutting/machining the set of geometries 300, 302, 304 from a decided length of a bar material 306. The communication device 401 may be arranged to receive feedback from the machining and/or cutting facility 415, e.g. by means of the receiver 402. The decision unit 410 may be arranged to decide on a length 308, 405 of a bar material 306, 404 at least based on the feedback from the machining and/or cutting facility 415. The presentation unit 408 may be arranged to the present a candidate set of lengths of bar material 306, 404, and the decision unit 410 may thus be arranged to select a best fit of lengths from the candidate set of lengths of bar material 306, 404. The communication device 401 may be arranged to communicate with a delivery service 422 configured to deliver bar material from the bar material provider or producer 412 to the machining and/or cutting facility 415. Further, the system 400 may comprise a monitor 424 for dynamically monitoring and/or controlling the at least one calculated, presented and/or decided length 308, 405 of a bar material 306, 404. According to aspects of the system 400, the system 400 is arranged to create machining and/or cutting instructions for machining and/or cutting the set of geometries from the decided length 308, 405 of a bar material 306, 404.

With reference to FIG. 4A, a machining and/or cutting system 426 is also provided, comprising the system 400 as disclosed above. The machining and/or cutting system 426 also comprises a machining and/or cutting facility 415 including machining and/or cutting equipment 428 for machining and/or cutting the set of geometries 300, 302, 304 from the decided length 308, 405 of a bar material 306, 404. The machining and/or cutting equipment 428 may comprise a turning apparatus, a sawing device, a beam cutting device, a flame or torch cutting device, a water cutting device, or an air cutting device. Examples of beam cutting devices are a laser device, a plasma cutting device, an ion beam cutting device.

The system 400 may be remote to the machining and/or cutting facility 415 and remote to the bar material provider or producer 412. The system may be remote to the delivery service 422.

The system 400 may include a computer aided design, CAD, tool, and/or a computer aided manufacturing, CAM, tool, and/or a computer numerical control, CNC, tool.

With reference to the embodiment of FIG. 4B, the system 440 may also comprise a central computer 450 arranged to create commands, or instructions, to be communicated to the bar material provider or producer 412 and arranged to communicate with the bar material provider or producer 412. The central computer 450 may be arranged to check the accessibility of the at least one length of a bar material at the bar material provider or producer 412. The central computer 450 may also be arranged to create commands, or instructions, to be communicated to the machining and/or cutting facility 415 and is arranged to communicate with the machining and/or cutting facility 415. The central computer 450 is arranged to communicate with the communication device 401. The central computer 450 may also be arranged to the communicate with the database 414 and with the delivery service 422.

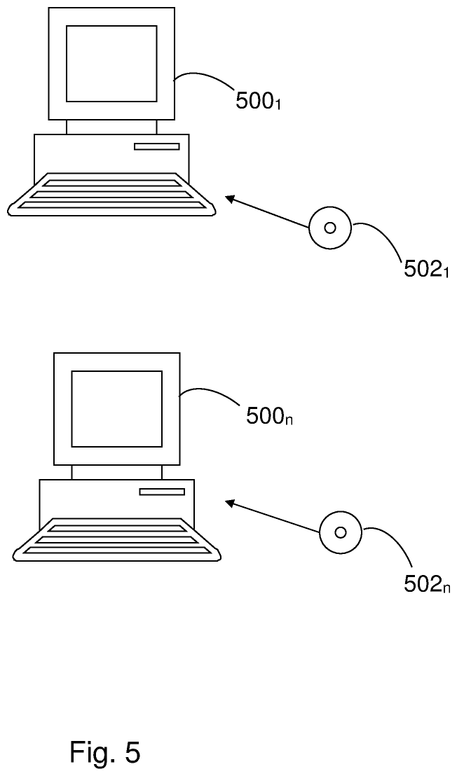

In FIG. 5 there is disclosed a schematic diagram of some computer program products. There is disclosed n different digital computers 500₁, . . . , 500ₙ, wherein n is an integer. There is also disclosed n different computer program products 502₁, . . . , 502ₙ, here showed in the form of compact discs. The different computer program products 502₁, . . . , 502ₙ are directly loadable into the internal memory of the n different digital computers 500₁, . . . , 500ₙ. Each computer program product 502₁, . . . , 502ₙ comprises software code portions for performing some or all the steps of FIG. 1 or FIG. 2 when the product(s) 502₁ . . . , 502ₙ is/are run on said computer(s) 500₁ . . . , 500ₙ. Said computer program products 502₁, . . . , 502ₙ can e.g. be in the form of floppy disks, RAM disks, magnetic tapes, opto magnetical disks or any other suitable products.

The above-mentioned features and embodiments of the different embodiments of the methods, systems and computer programs, respectively, may be combined in various possible ways to provide further advantageous embodiments.

The invention shall not be considered limited to the embodiments illustrated but can be modified and altered in many ways by one skilled in the art, without departing from the scope of the appended claims. It is to be understood that one or more steps may be excluded from the disclosed embodiments of the methods, or an additional step or steps may be added.

1. A method for preparing machining and/or cutting of a bar material, the method comprising the steps of:
obtaining a set of geometries to be machined and/or cut from a bar material;
calculating at least one length of a bar material based on the geometries;
presenting the at least one calculated length of a bar material; and
deciding on a length of a bar material at least based on the at least one presented length of a bar material.

2. A method according to claim 1, characterized in that the step of calculating at least one length of a bar material includes the positioning of the set of geometries on a bar material.

3. A method according to claim 1, characterized in that the step of presenting the at least one calculated length of a bar material comprises the step of presenting the at least one calculated length of a bar material to a bar material provider or producer which provides or produces bar material lengths.

4. A method according to claim 3, characterized in that the at least one decided length of a bar material is produced by the bar material producer after deciding on the length of a bar material and/or after checking the accessibility of the at least one length of a bar material at the bar material producer.

5. A method according to claim 4, characterized in that a central computer creates instructions to be communicated to the bar material provider or producer and communicates with the bar material provider or producer.

6. A method according to claim 3, characterized by the step of receiving feedback from the bar material provider or producer, and in that the step of deciding on a length of a bar material is at least based on the feedback from the bar material producer.

7. A method according to claim 6, characterized in that the received feedback from the bar material provider or producer includes the accessibility of the at least one length of a bar material.

8. A method according to claim 3, characterized in that the bar material provider or producer includes a computer-readable storage medium or a database including lengths of bar materials.

9. A method according to claim 3, characterized by the step of communicating the presented and/or decided length of a bar material to a machining and/or cutting facility.

10. A method according to claim 9, characterized by the step of receiving feedback from the machining and/or cutting facility, and in that the step of deciding on a length of a bar material is at least based on the feedback from the machining and/or cutting facility.

11. A method according to claim 3, characterized by the step of communicating with a delivery service configured to deliver bar material from the bar material provider or producer to the machining and/or cutting facility.

12. A method according to claim 3, characterized in that the bar material provider or producer presents accessible bar material or a plurality of accessible bar material candidates, e.g. via a central computer, and characterized in that the step of calculating at least one length of a bar material based on the geometries includes finding the best fit with accessible length or lengths of bar material.

13. A method according to claim 1, characterized in that the step of calculating at least one length of a bar material based on the geometries comprises calculating the extension of the positioned geometries and/or calculating the amount of scrap material obtained from the bar material, wherein the extension at least represents a kerf width for machining or cutting the bar material, and characterized by including the extension and/or the amount of scrap material in the presentation of the at least one calculated length.

14. A method according to claim 1, characterized in that the step of presenting the at least one calculated length of a bar material comprises presenting a candidate set of lengths of bar material, and in that the step of deciding on a length of a bar material comprises selecting a best fit of lengths from the candidate set of lengths of bar material.

15. A method according to claim 1, characterized in that the step of calculating at least one length of a bar material comprises repeatedly altering the positioning of the set of geometries, and in that the step of deciding on a length of a bar material comprises deciding on a best fit of lengths to the altered positioning of the set of geometries in order to obtain a candidate set of lengths of bar material.

16. (canceled)

17. A method according to any of the claim 1, characterized by the step of creating machining and/or cutting instructions for machining and/or cutting the set of geometries from a length of a bar material.

18. A machining and/or cutting method, characterized by comprising a method as claimed in claim 1, and characterized by machining and/or cutting the set of geometries from the decided length of a bar material.

19. (canceled)

20. A system for preparing machining and/or cutting of a bar material, wherein the system comprises a receiver for obtaining a set of geometries to be machined and/or cut from a bar material, a calculator for calculating at least one length of a bar material based on the geometries; a presentation unit for presenting the at least one calculated length of a bar material; and a decision unit for deciding on a length of a bar material based on the at least one presented length of a bar material.

21-30. (canceled)

31. A machining and/or cutting system, characterized by comprising a system as claimed in claim 20, and characterized in that the machining and/or cutting system comprises a machining and/or cutting facility including machining and/or cutting equipment for machining and/or cutting the set of geometries from the decided length of a bar material.

32. (canceled)

33. A non-transient computer-readable storage medium containing data representing coded instructions configured for execution by a processor of a computer, the instructions comprising the steps of a method as claimed in claim 1.
